(19) United States
(12) Patent Application Publication
(10) Pub. No.: US 2009/0067625 A1
(43) Pub. Date: Mar. 12, 2009

(54) Method for protection of digital rights at points of vulnerability in real time

(75) Inventors: Pankaj Patel, San Jose, CA (US); Vijay Desai, Fremont, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Aceurity, Inc.

(21) Appl. No.: 11/899,698

(22) Filed: Sep. 7, 2007

(51) Int. Cl. H04N 7/167; H04K 1/00

(52) U.S. Cl. 380/201; 380/210

(57) ABSTRACT

As transmitted digital content is vulnerable commodity, its protection from piracy is receiving significant attention. It is possible today to extract the digital content from the temporary storage during processing and also form interfaces during transfer between blocks in a receiver system. When content is processed and frames are temporarily stored in external memory, when frames are transmitted to the display through a LVDS, or other screen/panel interface, they are transmitted non-secured. When captured at these points of vulnerability, the full resolution image is available for reproduction. According to the present invention additional security protection is enabled at these points of vulnerability. The disclosed practice of randomized scrambling of bits or groups of bits at the points of vulnerability in a digital transmit-receive system prevent pirating of useable content.

### BACKGROUND OF THE INVENTION

1. Field of the Invention

The invention generally relates to the protection of transient digital, and more specifically the protection of the transient digital content from piracy at points of vulnerability such as at execution, processing, transmission, reception, temporary storage, and viewing.

2. Prior Art

FIG. 1, comprised of FIGS. 1A, 1B and 1C, shows a transmission system for digital content. Present real time content transmission systems 100 use complex encryption/decryption schemes to provide security and protect the digital content from piracy. These encryption and decryption schemes introduce latency, increase need for storage and reduce the performance of the system. In addition, today's method lacks protection and is vulnerable to piracy at multiple points in the processing system.

FIGS. 1A, 1B and 1C show an exemplary block diagram of a typical data or content transmission system. The generated video data is first encoded. This encoding takes 3 to 12 frames at a time, illustrated as 101 in FIG. 1A. The motion or change between the frames is extracted in the motion extraction module 102. This change information is transformed using Discrete Cosine Transform (DCT) or Discrete Wavelet Transform (DWT) and then quantized in the transform/quantization module 103. This transformed information is then passed to the Entropy module 104 for lossless compression. The compressed data is then secured using the Advanced Encryption System (AES_E) in block 105. The output is made available as transmitted content.

FIG. 1B shows the block diagram of a content receiver. At the receiver 110 the compressed and AES encrypted data/content is received and decrypted using the AES decryption (AES_D) algorithm in block 111. The extracted compressed data is temporarily stored in the temporary memory. 112. It is extracted from the memory and the AES_D block 111 passes this output to the decoder. The output of this block is decompressed and converted back to the content stream in the decoder 113 by adding the entropy and decoding, typically by Inverse DCT or Inverse DWT. During decode, the recovered frames again have to be temporarily stored in process memory 114, typically either double data rate (DDR2) memory or synchronous dynamic random access memory (SDRAM) through the memory bus 117. This is necessary so as to reconstruct the following frames by adding the motion change to the previous stored frames. This frame storage is of the raw content, that is, data with clock information in frame format and is not in a protected state. The data at this stage in the process is available for copying as frames. A typical frame of 1080 p/4:4:4/8 bit will require storage of approximately 6 MB (megabytes). This content is then retrieved from the temporary storage memory through the bus 117 and re-encrypted using High-bandwidth Digital Content Protection (HDCP) encryption scheme in the encryption module 115, and transferred over High Definition Multi-media interface (HDMI) connection 116 to the display.

Currently one effort at security is to integrate the temporary storage memory into the chip to eliminate the external tapping capability. Since the High Definition (HD) frames such as 1920×1080 require more than 6.2 MB/frame, huge amounts of memory have to be embedded on chip. This will make the chips more expensive to manufacture.

FIG. 1C is a typical block diagram of a content display receive system 120 showing the content path. Once the HDCP/HDMI content is received by the display converter system 120 through the HDMI input 116, it is decrypted using the HDCP decryption algorithm and decompressed in the decryption/decompression module 121, then decoded and de-interlaced in the extraction module 122, after which it is output as a parallel data stream. During this decoding and de-interlacing process the content stream is again stored in temporary memory 125 in an unprotected from. The extracted parallel data/content is taken from the memory 125 and reconverted to suitable serial streams of low voltage differential signal (LVDS) in the LVDS encoder module 123. This serial LVDS stream is connected to the display module 130, typically comprising a serial to parallel converter 131, a digital to analog converter 132, row and column drivers 133, and TV display screen 134, connected through LVDS or other screen/panel interface connector 124. The LVDS output is again in the unprotected state in the LVDS, or other screen/panel interface connector link 124, and can be easily accessed for pirating a copy of the original content.

Even in the display module, after the content is reconverted from LVDS to parallel data, it is buffered (not shown) and processed before being used to drive the pixels on the glass. The content again is stored in a temporary memory during this process. Here again the content is unprotected and susceptible to piracy.

The points in the content transmit-receive system where high quality digital content is available for unauthorized tapping are therefore (a) the temporary storage into memory of the frames during processing in a receiver system; and, (b) the transmission of the processed content from the receiver to the display using LVDS link 124. At all other exposed points in the transmit-receive system the content is encrypted/compressed by either AES or HDCP. At the locations noted, raw content, regenerated from the incoming stream, is unprotected and is available to be tapped and easily extracted. It would therefore be advantageous to provide a system and method that address these points of vulnerability. It would be further advantageous if such solution does not increase the delay inherent to such transmit-receive systems.

### BRIEF DESCRIPTION OF THE DRAWINGS

FIG. 1A is a typical block diagram of prior art content transmission system.

FIG. 1B is a typical block diagram of prior art content receiver system.

FIG. 1C is a typical block diagram of prior art content display system.

FIG. 2 shows the possible number of permutations for each group of elements, typically bits.

FIG. 3 is an example of forming the index of different arrangements.

FIG. 4 shows examples of mode based selection of index groups.

FIG. 5 is a method of generating and randomly selecting the scrambling pattern or code to be used with the associated index.

FIG. 6 shows the transformation of an 8-bit data on a bus scrambled using of the principles of the invention and with respect to FIG. 5

FIG. 7 is a block diagram of the content receiver system in accordance with the disclosed invention for scrambling protection for temporary content storage.

FIG. 8 is a content display system implemented in accordance with the principles of the disclosed invention as enabled at the temporary storage and LVDS link.

FIGS. 9A and 9B show a flow chart of an exemplary temporary storage implementation.

### DETAILED DESCRIPTION OF THE PREFERRED EMBODIMENTS

This application is related to a co-pending patent application entitled “A Method of Generating Secure Codes for a Randomized Scrambling Scheme for the Protection of Unprotected Transient Information”, assigned to common assignee, the disclosure of which is hereby incorporated by reference.

As transmitted, digital content is a vulnerable commodity, and its protection from piracy is receiving significant attention. It is possible today to extract the digital. content from the temporary storage during processing and also from interfaces during transfer between blocks in a receiver system. When content is processed and frames are temporarily stored in external memory, when frames are transmitted to the display through an LVDS, or other screen/panel interface, they are transmitted unsecured. When captured at these points of vulnerability, the full resolution image is available for reproduction. According to the present invention additional security protection is enabled at these points of vulnerability. The disclosed practice of randomized scrambling of bits or groups of bits at the points of vulnerability in a digital transmit-receive system prevent pirating of useable content.

This invention covers protection of transient digital content at the points of vulnerabilities in real time. In a digital content transmit-receive system this invention can be used to protect content from being pirated wherever it is not secured by advanced encryption system (AES), high-bandwidth digital content protection (HDCP), or other encryption schemes. More specifically the disclosed invention covers the protection of digital content during execution, processing, transmission, reception, temporary storage, and viewing. The principles of the disclosed invention are especially applicable to real time video reception and processing.

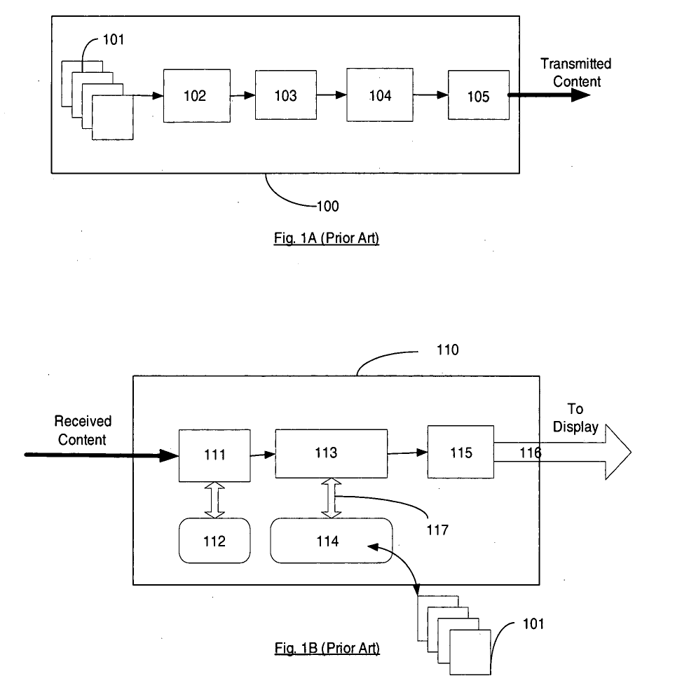

In accordance with the disclosed invention, a simple method to provide the necessary protection to the transient content is the use of the disclosed bit securing scheme, referred to herein as the Bitsecure scheme or Bitsecure for short. In a content transmit-receive system the Bitsecure scheme can be used while the content is in process and temporary storage, similar to the situation in the decoder in the block 113 in FIG. 1B, the extraction module 122 in FIG. 1C, and at the low voltage differential signal (LVDS) transmission between the receiver and the display. The use of the Bitsecure scheme makes the tapped content non-coherent and non-playable thereby protecting it from potential piracy.

One of the problems of adding standard encryption using currently available schemes is the delay injected and processing power needed to handle the encryption/decryption process at the interface. It is necessary to have a fast and easy method for handling the security of the content at these locations.

What is disclosed is a way of protecting the content using a security enabler which scrambles the data based on a randomly chosen scheme and that further is capable of the descramble of the data that is returned based on the scrambling scheme chosen. This is done simply by choice of an index that defines a random scrambling pattern scheme and storing that index value and associated pattern until the data that is scrambled has been recovered.

Bitsecure needs a way of generating large numbers of patterns for scrambling of the data/content on a bus. The method of generating this is described in detail in the co-pending patent application “Method of generating secure codes for Bitsecure scheme”, assigned to common assignee and the disclosure of which has been incorporated herein by reference. Having a large number of available possibilities, or patterns, for scrambling or flipping the bits on the bus with the associated index, makes it impossible to reconstruct the content stream without the associated index and hence the scrambling pattern or scrambling code. This scheme that makes the scrambling code and index a transient, is close to being the ideal scratch pad security scheme.

Development of a large population of randomizable patterns and choice of the usable transient patterns.

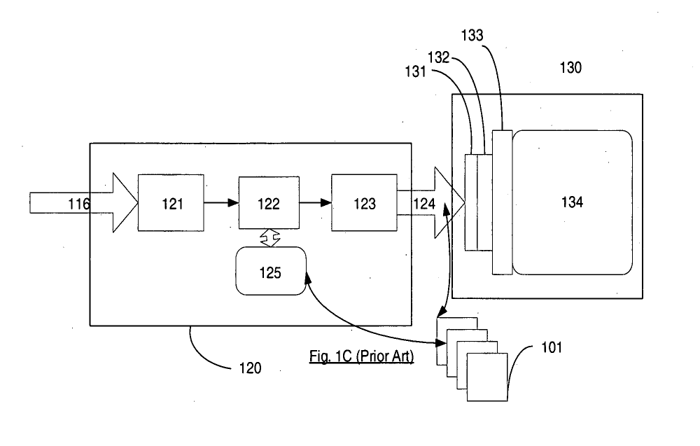

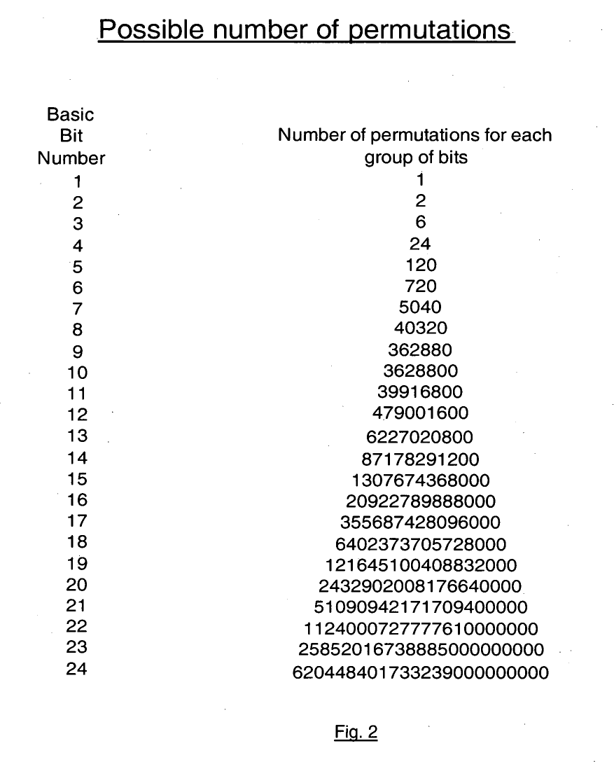

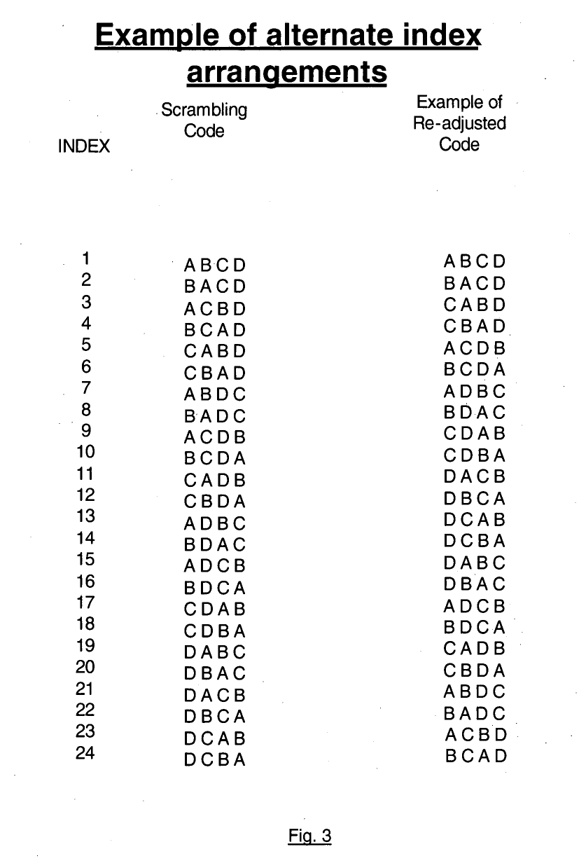

The first step in the process is to divide the stream into groups of bits that may be of any width. An N bit grouping can produce N factorial combinations. Thus a 4 bit grouping can produce 24 combinations while an 8 bit grouping will provide over 40K permutations and a 16 bit grouping can produce a 20×10¹² combinations. FIG. 2 shows the growth of permutations with use of ever larger number of bits chosen as a group for scrambling. A 4 bit grouping providing 24 permutations is shown in FIG. 3. Also shown is an alternate or re-adjusted arrangement of the permutations available, thereby changing the index of the scrambling patterns or codes. By way of example, the re-adjusted arrangement may be a random or pseudorandom re-adjustment. Hence a proper choice of bit grouping can be used to provide a suitable number of combinations of bits. In a typical implementation, an 8 bit grouping is more than enough to create the number of patterns and index to make the security acceptable. In a case where very high security is needed the number of bits chosen in a group can be 16 or 24 bits providing a very large group of possibilities. Typically a smaller set (subset) of these possible patterns are randomly chosen to create a table of groupings together with their presently assigned index as a look up table. This can be done conforming to some. specified mode format if so chosen rather than at random. Three such mode based arrangement examples for a 4 bit grouping are shown in FIG. 4.

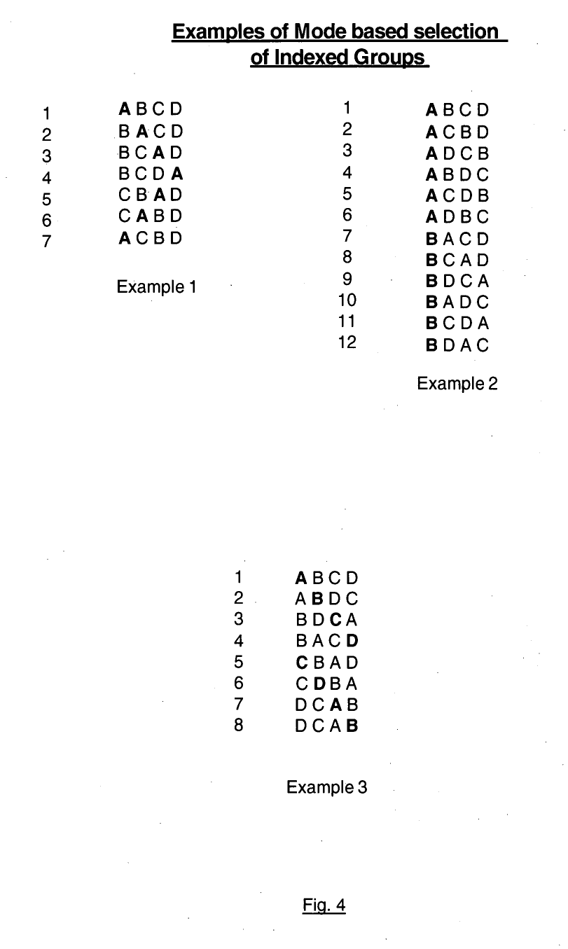

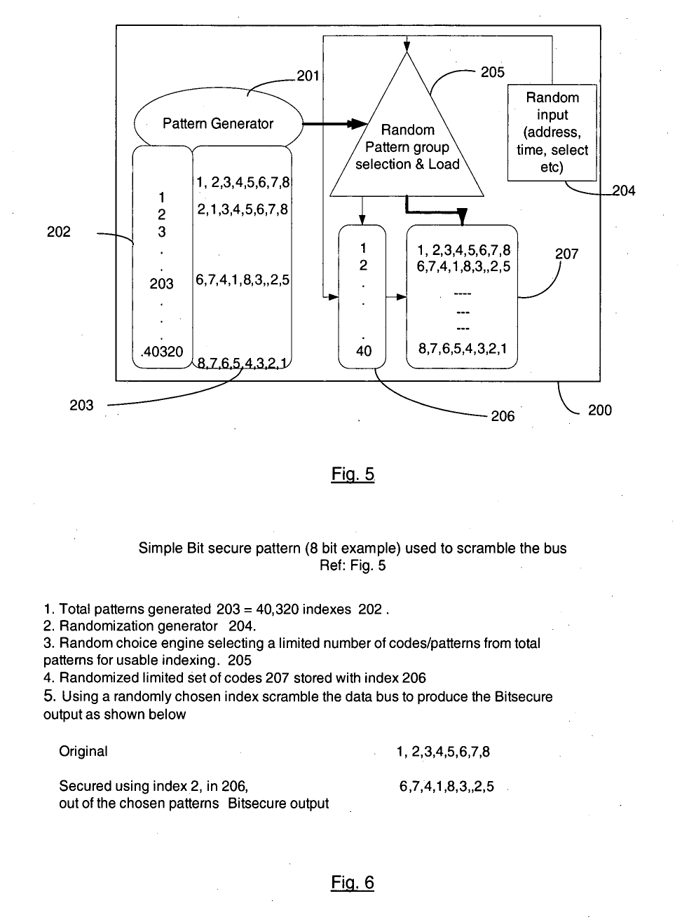

Reference is now made to FIG. 5 where a typical method of generating and storing the scrambling pattern or scrambling code table for use is shown. This can be done each time the unit is switched on, based on a completely randomized pattern generator, without a fixed starting seed, that selects the group of patterns to be used at random from the total number of patterns generated. These selected patterns can be stored in non-volatile memory and used for enabling the scrambling in cases where the security is to be established. This generation and selection is done in a Pattern Generator and selector module 200. FIG. 6 shows a simple scrambling transformation for use in the Bitsecure scheme. Alternately, for very high security needs, the selection of the set of scrambling codes/patterns with index can be done during processing of the content stream, based on random input features, the chip select of the RAM to be loaded, the initial address of the content to be transferred, the first byte of the content, other appropriate triggers, or any combination thereof. These patterns with index are stored in the pattern table for use by the system. Similarly the starting index and hence the pattern group associated with it, from the chosen scrambling table comprising the index and the pattern, is also randomly chosen for use during each implementation of the bit secure. In a temporary storage situation, the index used is stored in a latch in a security enabler, with the chip-select and address information. This information stored in the latch is used to retrieve the scrambling pattern during descrambling of the stored scrambled content. The chosen pattern is used to create the bit scrambling prior to transferring the information out to the memory at a location chosen by the chip-select and the address. A pattern index can be used with each frame, or a set of frames, and then changed, each time storing its address with the index. It is also possible to use the same pattern and index for multiple frames using timing or other discriminating conditions. The pattern change can be optimally based on randomizing events such as a change in the chip-select or appearance of a chosen address input etc. Any time a selected pattern is changed based on a criterion chosen, the new index with associated addresses is stored in a different latch. The old index is kept and used till all the frames that were temporarily stored have been brought back and de-scrambled in the decoder. This way a continuity of the pattern recovery, through the stored index, is maintained through the use of two index latches. A typical selection and use of the indexed scrambling patterns for an 8 bit byte is shown in FIG. 6.

Though Bitsecure bit scrambling is mentioned and described for protection of the content stream, that does not in any way prevent or limit the use of this disclosed invention for scrambling of groups of multiple bits using the same procedure to achieve good security. It is possible to use the Bitsecure to improve the security of other transient or short term storage applications to improve security of data. One such application is the use of the disclosed method to store operating code in external memory of a processor or controller so as to prevent unauthorized copying or implementation.

Use of the Bit secure scheme for securing the content at points of vulnerability:

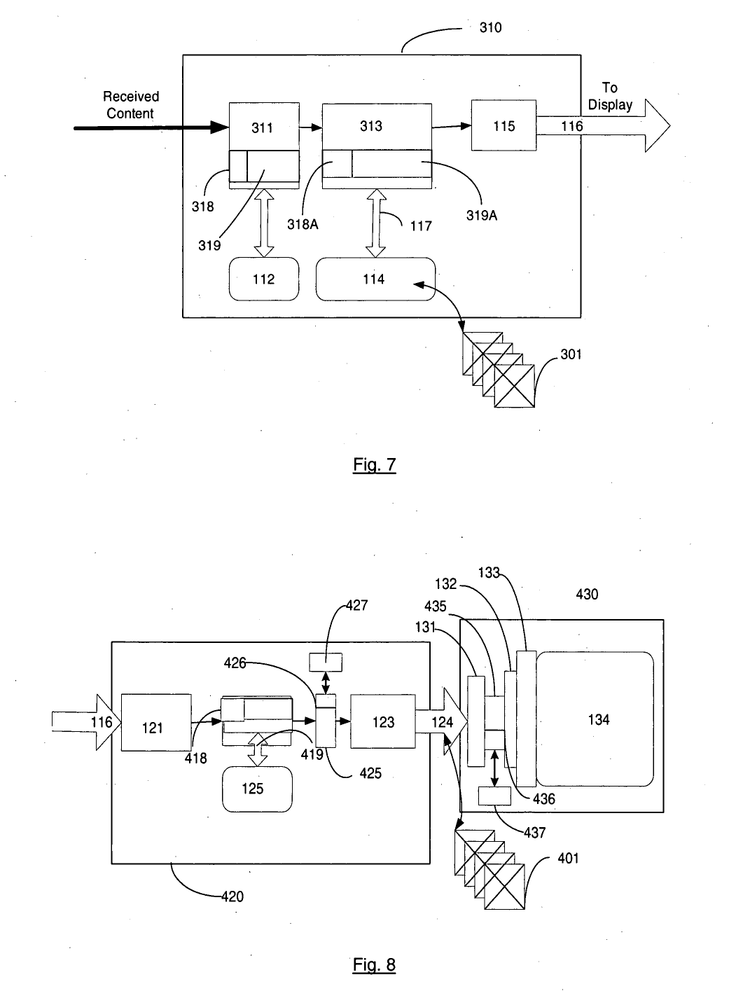

FIG. 7 shows an exemplary and non-limiting use of the Bitsecure scheme. It shows the data scrambling block diagram of a receiver 310. At the receiver 310 the compressed and AES encrypted data/content is received and decrypted using the AES decryption algorithm (AES_D) in block 311. The extracted compressed data is scrambled using the disclosed art and stored in the temporary memory block 112. The scrambling is done using the well understood multiplexing circuits in the scrambler/descrambler block 319 of the AES_D block 311. The scrambling is driven by a randomly selected value of the scrambling index generated and transferred from the prior explained generation and selection module 200 and stored in the security enabler 318 that randomly chooses the scrambling code to be used for scrambling the content stream. The index is stored in a latch for use during descrambling of the scrambled data on retrieval of the same from storage. The operation of the scrambling/descrambling is the same as described later with reference to the temporary storage during the processing of the content in the decoder. The stored content is extracted from the memory 112 and descrambled in the scrambler/descrambler 319 and the AES_D block 311 passes this output to the input of decoder 313. The input is decompressed and converted back to the content stream in the decoder 313 by adding the entropy and doing decoding typically by Inverse DCT or Inverse DWT. During decode the recovered frames again have to be temporarily stored in process memory 114, typically either DDR2 or SDRAM through the memory bus 117. This, as has been explained hereinabove, is necessary for the reconstruction of the following frames by adding the motion change to the previous stored frames.

In the prior art, this frame storage was of the raw content, that is, data with clock information in frame format and is not in a protected state. In the disclosed art using the decoder 313, the data is scrambled using well known mutiplexer circuits and techniques, on the output portion of the internal bus, in the scrambler/descrambler 319A of the decoder 313. The scrambling is driven by selecting a scrambling index value in a security enabler 318A, from a group of scrambling indexes. Each scrambling index selects a different scrambling pattern from a very large number of possible scrambling patterns or codes available as explained later. The data is scrambled on the output bus at the scrambler/descrambler block 319 prior to the data appearing on the memory bus 117. The data at this stage in the temporary storage is in a scrambled format and is hence not available for recovery and copying as frames.

A typical frame of 1080 p/4:4:4/8 bit requires a storage of approximately 6 MB but in a scrambled state. This scrambled content is then retrieved from the temporary storage memory through the bus 117 and as it is transferred to the internal bus of the decoder through the scrambler/descrambler 319, it is descrambled using similar multiplexing to produce the original content using the same scrambling index information available in the security enabler. The scrambling and descrambling is through choice of gates and introduce only a few gate delays in the path. It also does not manipulate the data itself, but only scrambles the output bus position based on the index chosen.** The disclosed Bitsecure scheme uses scrambling and descrambling of content on the bus, hence provides the original frame data as frames that are retrieved without introducing undue delay and increasing the processing power needs of the decoder. This recovered content is then re-encrypted using high-bandwidth digital content protection (HDCP) encryption scheme in the encryption module 115, and transferred over high definition multi-media interface (HDMI) connection 116 to the display system.

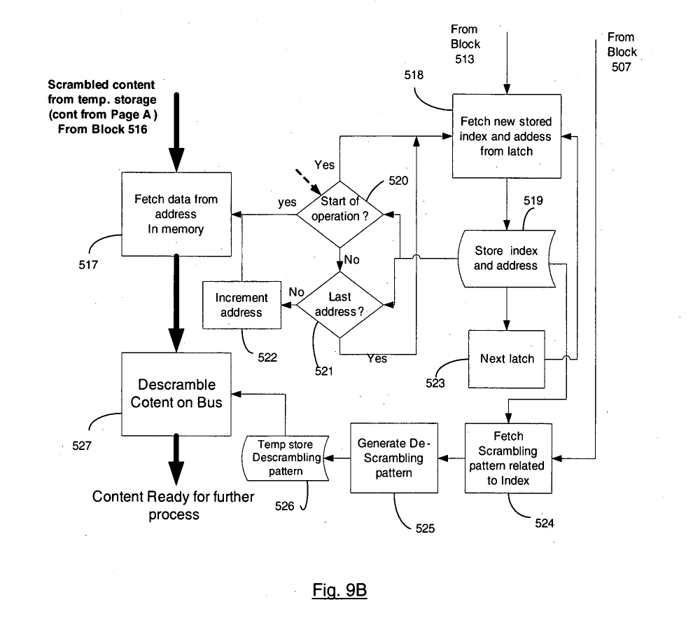

FIGS. 9A and 9B show an exemplary and non-limiting flow chart of the temporary storage of content using the Bitsecure scheme proposed. In the Bitsecure scheme all the modules/components of the scheme are part of the integrated system blocks and only the temporary content storage memory is external to the system. The operation can be described using this flow chart. Since the bus width is a known quantity it can be divided into an integer number, 1 to n, of equal units for scrambling, each unit consisting of a sub set of the bits on the bus , as shown in block 501. In the typical example, all the possible permutations of the bits in a unit are calculated in 502 and stored during initial configuration of the system in permanent storage 503.

During power up the power up control 504 provides a signal to random selection block 505, which is used to generate a random selection, without any fixed seed, and select a sub-set of the stored permutations from 503. This set of temporarily chosen patterns are assigned index numbers, starting at a random pattern within the chosen patterns, such that the index numbers do not have any repeating assignment characteristics by the index number assigning block 507. Hence this scrambling pattern set with its attached indexes is changed at each power up of the system in this exemplary and non-limiting implementation of the scheme.

In the exemplary and non-limiting example the sampling pattern is selected at power up and at fixed intervals (clock driven) by the selection unit 508 based on input from 509 and 510. The selection it self is again a random pick of the index by block 508 followed by a fetch of the pattern by block 511 from the temporary store at 507.

Hence there are three random operations that make enable the selection of the pattern to be used and this makes prediction of the pattern used at any point in time very difficult if not impossible. The selected index and the start and stop address in the external memory storage 516 for each scrambling pattern, are stored for use during retrieval of data from storage in latches 513.

The pattern itself is temporarily stored 514 during its use to scramble the content data bits on the bus 515. This scrambled content protected by scrambling is stored in the external temporary storage memory 516 during the processing of the content stream.

During retrieval of the content stream from the memory 516 the operational loop consisting of 520 and 521 is used to decide if a new index and start-stop address information for the associated pattern should be fetched from the storage latches 513. This is done at the start of the de-scrambling cycle and after the last address for a specific index and associated scrambling pattern has been retrieved 518. The new index and associated start stop information are stored 519. The index is used to fetch the scrambling pattern used 524. The de-scrambling pattern is generated at 525 and temporarily stored during use 526. This pattern is used to descramble the content and data 527 for further process inside the system.

As can be seen the data is never in a state that is usable during temporary external storage. It is in a fully protected state by scrambling. The scrambling and de-scrambling patterns are difficult to decipher as it is generated in a multi stage randomizing scheme.

Even though the securing of the content during processing and temporary storage is explained using the receiver system, the disclosed Bitsecure scheme and methods thereof can be used effectively to enable protection of the content that is stored during processing in the display system at the decoding/de-interlacing stage and also in the display during processing of the content after conversion to parallel stream of the serial LVDS input.

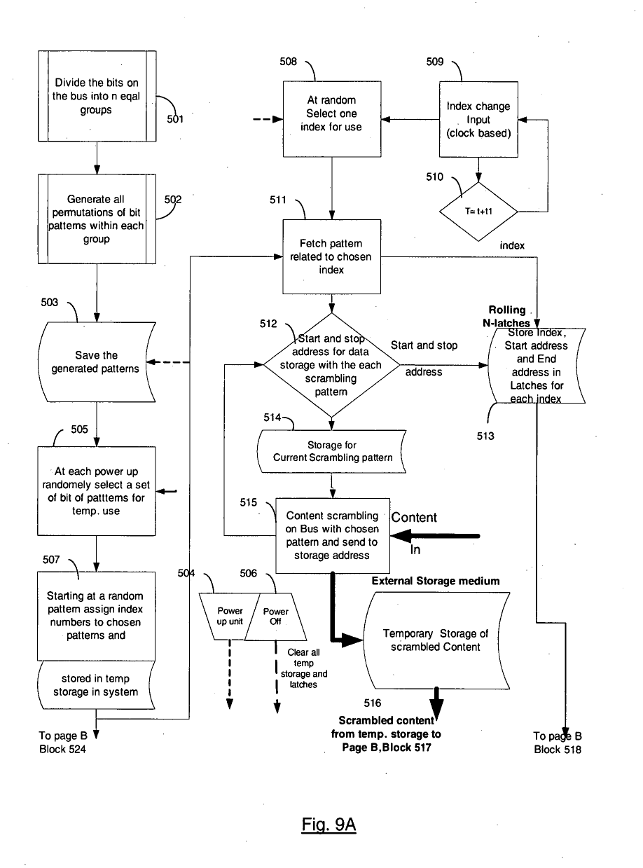

The disclosed Bitsecure scheme can be used at the LVDS or other screen/panel interface connection link used for transmission between the receiver and the Display. Reference is now made to FIG. 8 where the block diagram of a content display system of the video path with the disclosed Bitsecure scheme enabled is shown. In this case a table of scrambling patterns, or codes, with the associated index, generated and transferred from the generator and selector module 200 described previously, is stored in two random access memories (RAMs) on both the receiver, source side, and also on the display, sink side. These scrambling codes with associated index are changed every time the system is turned on to prevent a fixed set of codes always being in memory. The only additional information needed for descrambling of the LVDS incoming information at the receiver is the scrambling index which is sent over prior to the content transfer typically over the same LVDS link used for content transfer from the source to the sink. It can also be sent over separate control signal link to avoid sending extra identifiers.

Once the HDCP/HDMI content is received by the display converter system 420 through the HDMI input 116, it is decrypted using the HDCP decryption algorithm in the decryption and decompression module 121, decoded and de-interlaced in the extraction module 422, and then output as a parallel data stream. During decoding and de-interlacing the content is stored in an external memory 125 secured by the disclosed Bitsecure scheme similar to the one described before. The processor 422 during processing temporarily stores the data as scrambled content using bit secure scheme in external memory. The scrambler/descrambler 419 and the index latch 418 are used as previously explained to achieve the scrambling and de-scrambling of the content. This extracted parallel content is retrieved from the memory and passed through the bus scrambler block 425 to produce scrambled output. The scrambler is enabled by a security enabler 426 that generates a scrambling index value and extracts a scrambling pattern from a table of patterns stored in the memory 427. This scrambled data is converted to suitable serial streams of low voltage differential signal (LVDS) in the LVDS encoder module 123. This serial LVDS stream is connected to the display module 430 screen/panel interface connecter 124. The chosen index is, through the LVDS or other also passed on to the display module 430 prior to the content transfer, typically over the LVDS link.

In the display module, the LVDS stream is reconverted to a parallel content stream using the serial to parallel converter 131. This parallel stream is descrambled in the descrambler 435 first by identifying the scrambling pattern using the transferred index in the security enabler 436. The associated descrambling pattern from the memory 437 is used to descramble the data/content on the link. This descrambled content is processed and then converted to analog in the analog converter 132, when necessary to use analog signal for the drivers. During processing in the display module this content is stored in the temporary memory using the disclosed Bitsecure scheme (not shown). The content is retrieved and sent to the appropriate row and column drivers 133 to be displayed on the display screen 134. The LVDS output is now in a scrambled protected state in the LVDS or other screen/panel link 124 and cannot be easily accessed for providing pirated copy of the original content.

The memory used for storage can be static RAM (SRAM), dynamic random access memory (DRAM) or non-volatile memory (NVM). The SRAM and DRAM loose information each time the system power is turned off. Hence, using a SRAM or a DRAM requires the generation and storage of the scrambling patterns with their index, each time the system power is turned on. The NVM, on the other hand, can retain the stored information even when power is removed. Hence, use of NVM to store the scrambling patterns and the index allow the system to generate and store the patterns when the system is configured. NVM usage also allows generation of the scrambling pattern at the factory providing the capability to store different, randomly chosen scrambling pattern groups for each manufactured system.

It is possible to use of the disclosed Bitsecure scheme whenever the content has to be transferred over local links within a system, in an unprotected state. The use of the disclosed Bitsecure scheme prevents capture and unauthorized use of the content in such instances.

It should be noted that what has been described is a typical exemplary and non-limiting receiver, wherein the points of security risk, during processing and transmission, are identified. There may be other processing sites with temporary storage and intermediate transmission points in the system, depending on system design. The disclosed Bitsecure scheme can be effectively used to protect the content at any of these processing, storage points, and transmission points, and are specifically considered to be an integral part of the disclosed invention.

The disclosed Bitsecure scheme is easily implemented in the current and future systems as it introduces only a few transmission gate delays and can operate in the same clock cycle without introducing any clock delay. What has been therefore disclosed is the use of the Bitsecure scheme of scrambling data and content prior to processing, temporary storage, and transmission between blocks, such that the content that is processed, stored or transmitted, is not easily readable and hence is not usable if pirated. The invention disclosed herein therefore provides protection to the transient digital content at points of vulnerability in real time, more specifically in a digital transmit and receive, and even more specifically for use in display systems like high-definition television systems. The disclosed methods and system may be implemented in hardware, software, firmware, or any combination thereof. Also the word random has been used herein in the general sense, and includes pseudo-random, or any other method to provide unpredictability.

While certain preferred embodiments of the present invention have been disclosed and described herein for purposes of illustration and not for purposes of limitation, it will be understood by those skilled in the art that various changes in form and detail may be made therein without departing from the spirit and scope of the invention.

What is claimed is:

1. A method of protecting digital content comprising:
generating a set of patterns for scrambling the digital content;
assigning an index number to each pattern of said set of patterns;
randomly selecting an index number from the assigned index numbers;
using the pattern associated with the randomly selected index number for scrambling of the digital content;
storing the scrambled digital content in temporary memory;
storing the index and memory address information in temporary storage to enable the retrieval of the scrambling pattern for descrambling of the stored scrambled digital content when retrieved; and
deleting said index number and said memory address once all the digital content using the scrambling pattern has been retrieved and descrambled;
such that the temporarily stored digital content is protected by the scrambling against extracting or pirating of the stored digital content.

2. The method of claim 1, wherein the set of patterns is a subset of a larger set of patterns.

3. The method of claim 2, wherein the subset of patterns is varied with time.

4. The method of claim 1, wherein the index numbers are randomly assigned to each pattern.

5. The method in claim 1, wherein the randomly selected index number is chosen for use based on a random incident.

6. The method of claim 1, wherein said random incident is at least one of: the value of the n^{th} byte of the digital content, and the memory information.

7. The method in claim 1, wherein the randomly selected index is changed in a time dependant fashion.

8. The method of claim 7, wherein said randomizing event is one of: a change in the a control signal causing a change in the selection of a memory block, and the appearance of a chosen set of sequential bits in an address input.

9. The method in claim 1, wherein the randomly selected index is changed on occurrence of a randomizing event.

10. The method in claim 1, wherein the descrambling of the digital content is performed using the index and memory address stored in a latch in a security enabler to retrieve the scrambling pattern used for scrambling the digital content.

11. A method of protecting digital content during transport from a source to a destination of a connection link, the method comprising the steps of:
generating a set of patterns for scrambling the digital content;
assigning an index number to each pattern of said set of patterns;
storing the index numbers and the corresponding patterns at the source and the destination of the connection link;
selecting randomly a specific pattern from the set of said corresponding patterns;
transferring the index number of said specific pattern over the connection link;
scrambling the digital content at the source using the specific pattern;
transferring the scrambled digital content over the connection link;
retrieving the scrambling pattern from the stored set of patterns at the destination using the corresponding index number; and
descrambling using the specific pattern the digital content;
such that the digital content transferred over the connection link is protected against reproduction if captured while being transferred over the connection link.

12. The method of claim 11, wherein the set of patterns is a subset of a larger set of patterns.

13. The method of claim 12, wherein the subset of patterns is varied with time.

14. The method of claim 11, wherein the index numbers are randomly assigned to each pattern.

15. The method of claim 11, wherein the transport is performed over a screen or display panel interface link within a receiver system.

16. The method of claim 15, wherein the interface is based on a low voltage differential signal (LVDS).

17. The method in claim 11, further comprising the step of:
generating the scrambling patterns and corresponding indexes upon applying power to the connection link.

18. The method in claim 11, wherein the storing is done in a dynamic random access memory, and requires the scrambling pattern and index to be generated and stored every time power is applied to the communication link.

19. The method in claim 11, wherein the storage is done in a non-volatile memory, allowing the scrambling patterns and index numbers to be generated and stored in the non-volatile memory in a factory during configuration of a system for practicing the method, allowing different systems to have different sets of scrambling patterns.

20. The method in claim 11, wherein the memory used is a non-volatile memory, the scrambling pattern and index numbers being generated randomly and stored into the non-volatile memory during application of power to the connection link.
